(19) United States
(12) Patent Application Publication
(10) Pub. No.: US 2021/0065092 A1
(43) Pub. Date: Mar. 4, 2021

(54) BUSINESS INTELLIGENCE THROUGH DATA VISUALIZATION

(71) Applicants: Amber Hart, Oakton, VA (US); Lisa Mundt, Reston, VA (US)

(72) Inventors: Amber Hart, Oakton, VA (US); Lisa Mundt, Reston, VA (US)

(73) Assignee: The Pulse of GovCon, LLC, Reston, VA (US)

(21) Appl. No.: 16/553,001

(22) Filed: Aug. 27, 2019

(51) Int. Cl. G06Q 10/06

(52) U.S. Cl. CPC G06Q 10/06393; G06Q 10/067

(57) ABSTRACT

The present invention includes a business intelligence system that scrapes data from various available WAN resources to aggregate captured data that supplies intelligence concerning contract activities, contract events, and social commentary concerning the same.

### FIELD OF THE INVENTION

The present invention relates to the field of business intelligence and more specifically to the field of commercial contracting.

### BACKGROUND

Each fiscal year, the U.S. Government (USG) awards roughly $500B in federal opportunities to businesses to meet the needs of federal agencies and the military. On average, a typical Government Contracting organization can spend approximately 30-35% of its revenue in the pursuit of these opportunities. In order to identify and pursue these opportunities, Government Contracting organizations have to research the demand and pricing for their product or service within the government.

FBO.gov, Grants.gov, and Challenge.Gov, Acquisition.gov, and SAM.gov are the five primary, web-based Federal platforms where USG federal agencies communicate and compete open procurement opportunities. These are the three legally binding federal opportunity platforms for the USG. USG intended to create these platforms as the sole source to help U.S. Government Contractors compete on open, federal opportunities and to assist the USG in the awards of these federal opportunities and in the legal communication of their needs with Government Contractors. Once a federal opportunity is legally awarded and a contract is executed between the USG and the awarded entity—it is manually documented, inputted, tracked, updated, and stored in the Federal Procurement Data System (FPDS). FPDS-NG is the single authoritative repository for federal procurement award data which is used to collect and report on federal procurement spending. FPDS feeds into several USG-created platforms such as USASpending.gov, DataLab, and Transparency.Treasury.gov to increase public understanding of USG spending.

This data can be used for geographical analysis, market analysis, and trend analysis of the impact of the congressional and presidential initiatives in socio-economic and capital industries. The data is also a reliable basis for measuring and assessing the impact of Federal acquisition policy and management improvement. Leaving such important platforms in the USG hands have left it leaps and bounds behind the up-to-date industry/commercial practices and technologies. Because of this, corporate organizations have developed “scraping” platforms that pull free data and present it verbatim in a cleaner format. These organizations charge thousands of dollars for data that they don't create and present it in their own “data dump” method.

Therefore, there is a need for structured searching and data to generate a business intelligence tool with superior manipulation and relational capabilities and display of publicly available data.

### SUMMARY

Government Contracts do not simply happen. They are living, breathing things. They have memories, historical data, are driven by personalities, shaped by Congress, the Executive, and lobbying powers and are impacted by the elements around them. They are not automated, and they do not burst on the scene arbitrarily. An objective of the present invention is to move the focus from sterile contract information and put it back on educating Government Contractors, the general public, venture capitalist, financial institutions (banks, lenders, etc.), and the federal workforce on the historical information and the supporting elements that shape them so that they may “bid with intent.”

As detailed above, USG provides free tools as open source data platforms which are completely accessible to registered Government Contractors—meaning Government Contracting organizations have everything they need to successfully compete within industry at zero cost. However, working with the USG can be complicated and feel confusing or even overwhelming and although the USG provides these sites for free, the information is hardly “at your fingertips.” These sites are very difficult to navigate—they do not have accurate keyword searches, they are clunky to use, visually unappealing, and inconsistently presented. Several corporate organizations have come in to take advantage of this confusion and have developed scraping sites for an inordinate amount of money. It has become the industry standard, and small socio-economic businesses have been fooled into thinking these sites provide any intelligence and analysis beyond what is out there for free.

Putting a human element back into Government Contracting requires a gentle reminder that at the end of the day that a person is selecting your company to provide the required service or product. Therefore, data alone is insufficient to understand the complexities of a USG opportunity. USG provided data relevant to Government Contracting has historically been overwhelming—with previously referenced external subscription services taking the “kitchen sink” mentality to information. Current industry practices, driven by these external subscription services, is to focus on important but incomplete items such as the “incumbent contractor,” ceiling value of the contract, status of the event, where to access the event, and historical information.

The present invention's intuitive platform will provide artificial snapshots of opportunity information at-a-glance on a standardized Graphic User Interface, which will act as a virtual “live feed” of pertinent, and sometimes selectable, industry, media, and federal information. If the user chooses to deepdive, the “softer” sciences of human behavior and interaction can be provided. Other available information can include historical trends plus relevant connections between contract activity, program/project evolution, greater impact of requirements (i.e. supporting Congressional initiatives/programs), and a contracting officers historical procurement trends and preferences

The present invention is related to a business intelligence visualization system. In a first embodiment of the present invention, there is provided a web scraper, a data analyzer, a rating algorithm, and dynamic visualization. The web scraper is adapted to access contract solicitation WAN resources, for the capture of information related to contract solicitation activities. The data analyzer is adapted to review the captured information from the web scraper to provide a conclusion based on contract solicitation activities correlated to a company. The relevancy algorithm or bot is adapted to review the adapted information to connect additional events of similar customer, size, scope, and complexity. The rating algorithm or bot is adapted to provide a quantitative score to the company based on the conclusion. The dynamic data visualization is preferably embodied in a scrolling ticker positioned on a visual electronic display displaying the company affected by the quantitative score with time indicia, including sequential arrangement, and a visual indication of said quantitative score. Other forms of data visualization may includes a depiction that: shows bar chart of agency event movements and awards made that day; shows bar chart of agency awards and total dollar value obligated that day, month, fiscal year; shows active chart of total agency obligations versus FY spending limits appropriated; shows sparkline chart of event statuses for that day measured against averages; shows the most recent events; shows recent media headlines, congressional reports, etc.; displays a calendar of industry related events (like industry days, etc.). Other forms of depictions can include graphics that show: bar chart of agency event movements and awards made that day; bar chart of agency awards and total dollar value obligated that day; month; fiscal year; active chart of total agency obligations versus FY spending limits appropriated; shows sparkline chart of event statuses for that day measured against averages; shows the most recent events; shows recent media headlines, congressional reports, etc.; a calendar of industry related events (like industry days, etc.).

Another embodiment of the present invention includes the webscraper, data analyzer, verification algorithm, scourer, and title generator. The web scraper is adapted to access contract solicitation WAN resources for the capture of information related to contract solicitation activities. The data analyzer is adapted to review the captured information from said web scraper, to provide (i) a conclusion based on contract solicitation activities correlated to a government agency, (ii) a conclusion based on correlating events participated in by the government agency correlated to the contract solicitation activities. The verification algorithm is adapted to verify said solicitation activities and the events from a primary or direct source web resource. The scourer is tuned to performing a supplemental search of statement-based web resources based on (i) said captured information and (ii) at least one of (a) the conclusions based on contract solicitation activities, and (b) the conclusion based on events participated in by the government agencies; the supplement search resulting in captured statement data. Results are depicted by a title generator outputting a uniform title script comprising contract and event variables, generated from a keyword search of said captured information. A graphic user interface is provided that includes a first data boundary consisting of listings of uniform title scripts concluded to be contract activities, a second data boundary consisting of listings of uniform title scripts concluded to be events; and a third data boundary consisting of listing of captured statement data consisting of information related to the contract activities and the events.

Another embodiment of the present invention includes a contract web scraper, adapted to access contract solicitation WAN resources, for the capture of information related to contract solicitation activities. Then an entity web scraper is adapted to access business resource databases, for the capture of information related to entity contract participation attributes associated with a competitive entity. There is a dossier database for the aggregation of competitive entity profiles based on both (i) the contract solicitation activities, and (ii) the entity contract participation attributes; and the competitive entity profiles including an entity profile score. There is a user profiler for collection of user contract participation attributes related to the user and generating a user profile with a user profile score. Then a contract aggregator finds, retains in memory, and arranges contract solicitation activities concluded to be contemporaneously available based on the user profile score.

These aspects of the invention are not meant to be exclusive. Furthermore, some features may apply to certain versions of the invention, but not others. Other features, aspects, and advantages of the present invention will be readily apparent to those of ordinary skill in the art when read in conjunction with the following description, and accompanying drawings.

### BRIEF DESCRIPTION OF THE DRAWINGS

FIG. 1 is a view of the system of the present invention.

FIG. 2 is a view of the system of the present invention.

FIG. 3 is a view of the system of the present invention.

FIG. 4 is a view of the system of the present invention.

FIG. 5 is a view of the system of the present invention.

FIG. 6 is a view of the system of the present invention.

FIG. 7 is a view of the system of the present invention.

FIG. 8 is a view of the system of the present invention.

FIG. 9 is a view of the system of the present invention.

### DETAILED DESCRIPTION

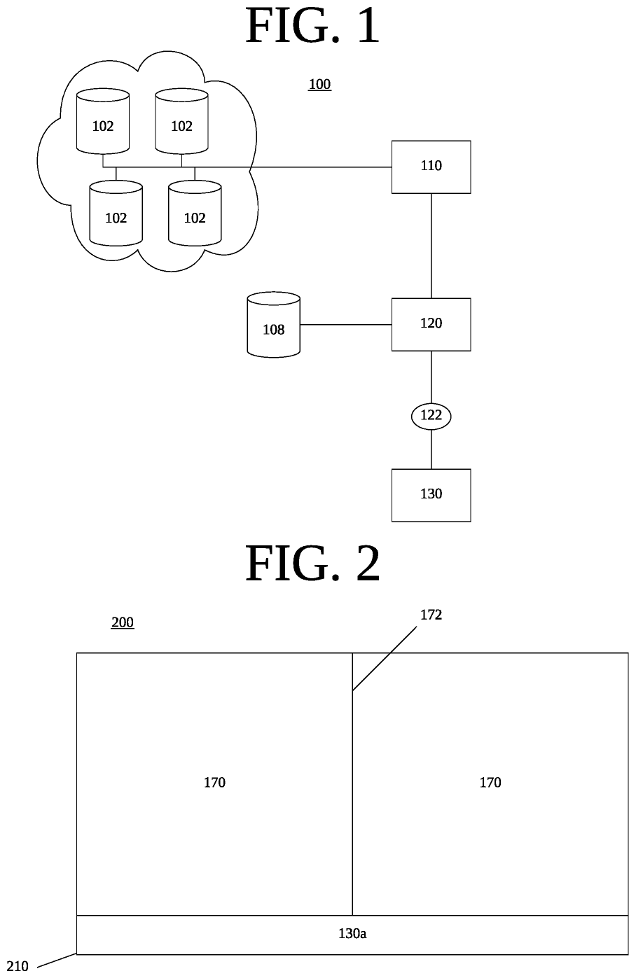

Referring first to FIGS. 1-2, a basic embodiment of the business visualization system 100 is shown. The business visualization system 100 is the culmination of a myriad of subprocesses comprising scouring bots 110, analyzers 120, verification bots 190, and various output techniques for aggregating data in an actionable, useful way.

The business visualization system includes one or more web scrapers 110, a data analyzer 120, an output generator 140 adapted to generate a rating pursuant to a rating algorithm, and dynamic data visualization 130 manifested as a scrolling ticker. The present invention as a business intelligence tools draws its information from Wide Area Network (“WAN”) resources 102 (e.g., web sites, File Transfer Protocol entities, etc.) on the WAN 790. As the business intelligence principally relates to information actionable to find and consummate commercial contracts related to the user's business abilities, the present invention can utilize multiple resources. WAN resources can include web sites and resources 102 of various applicability to business data. Direct source resources 102 include resources directly soliciting or providing contract information as provided directly by a contract seeker or an agent thereof. Direct resources can include government websites dedicated to statistics concerning government contract bidding, awards, appeals, values, etc; or government websites dedicated to posting contract availabilities and attributes of desired contractors; event details whereby a contracting entity goes to an outside location or the entity allows outside entities into its premises for purposes of contract relations and information. Indirect source resources 102 include resources provided by third parties, i.e. neither the user nor the contract seeker or agent, related to commercial contracts. Resources related to commercial contracts can include web sites that include contract monitoring web sites, news sources, magazines, networking websites, small business forums, technical presentations and/or demonstrations, and/or company web sites of contractors.

Social resources include statements from individuals and entities provided as commentary and unofficial statements. Social resources can include websites and resources where individuals provide information concerning themselves as applied to commercial contracts. Social resources differ from direct and indirect resources in that they are often unpolished, unauthorized, and can occur at the spur of the moment with little or no editing. Examples of social media can include TWITTER and FACEBOOK and LINKEDIN whereby the communications often concern the individual and his/her life, and there is merely a tangential relationship to contracts, contract activities, and other matters of concern to existing and potential contractors. As such, social resources require more highly-nuances scouring techniques and analysis, whereas direct source resources require less strenuous examination.

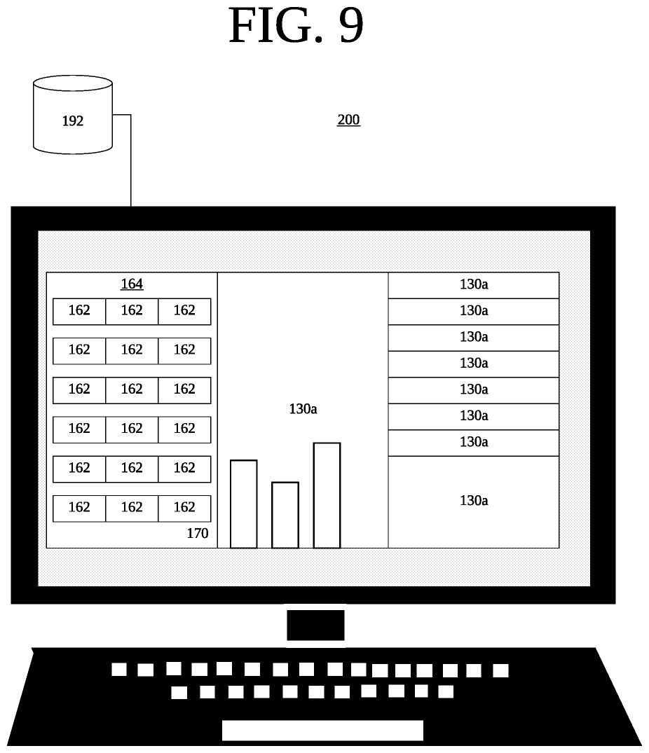

Turning to FIG. 9, the dynamic data visualization 130a of the present invention can also include indications of activity for social commentary. In a preferred version of the present invention, dynamic data visualization may include a scroller ticker with indications of a company, agency, contract, or other intelligence asset that is suitable to monitor. Naturally social commentary is not readily translatable to quantifiable results, however, the present invention can attempt to shoehorn and associate a quantity with social commentary. For example, in the scrolling ticker, a scraping bot can indicate social activity related to a company, agency, contract, etc. and provide indication of the activity. For example, through visualization, an emboldened indication of the entity can indicate positive commentary, whereas faint visualization can indicate negative commentary; or through visualization, green text or a +1 can indicate positive commentary, while red text or a −1 can indicate negative commentary. In various embodiments the significance and/or category of the “scored” activity (e.g., commentary) can be manually adjusted by a user for type and value. In other words, a user may desire that only employee commentary be visualized, or contract statuses be visualized. Multiple data visualizations may be used such that there is one visualization per contract/company/agency or other monitored entity.

The dynamic data visualization can include any form suitable to dynamically supply information representative of data changes to a user. For example, a heart monitor diagram can be used with a scrolling history to permit a user to be able to ascertain activity rates by the intensity and frequency of line changes. Accessing any particular line can lead the user to the information on which the activity was based. A growing bar chart could be utilized wherein commentary related to one or more companies could be compared side-by-side with the scoring/quantification based on predetermined categories of the user. For example, each contract action could be represented by a growth in a bar of the chart, or each piece of social commentary representing “buzz” could be maintained in each bar.

The present invention includes a web scraper 110 adapted to access contract solicitation WAN resources for the capture of information related to contract solicitation activities. Contract activities include all events, contract grants and other actions related to a commercial contract, particularly government contracts. The WAN resources involved can include direct source, indirect source, or social resources. The web scraper 110 will differ in the different circumstances and the data that the scraper is adapted to acquire. There can be one or more web scrapers based on the data required to be used with a particular user. A web scraper pointed to a direct resource can scrape data related to commercial and government contracts and the attributes of an existing or preferred potential provider. As direct source resources may have a section for contract bids and attributes, the web scraper can be pointed to such a section and have very flexible characteristics for the acquisition of resource data elements 162 as captured data 192. The web scraper for indirect source resources will likely require a stringent set of keyword information; however, the keyword information can be derived from the captured data 192 from the direct source web scraper. In other words, the present invention creates a derivative scraper that automatically uses keywords gleaned from reliable WAN resources to scrape and acquire information and relational data elements 162 from indirect resources or other resources.

In the embodiment of the present invention depicted in FIG. 1, the captured information 192 from WAN resources is passed to the data analyzer 120. The data analyzer 120 is adapted to review the captured information from the web scraper 110 and provides a conclusion based on contract solicitation activities correlated to a specific commercial entity, e.g. a company or organization. This embodiment is more directly related to business intelligence because a company (used herein to include any organization in pursuit of business opportunities) is tied to the business intelligence data. The data analyzer 120 is setup to provide output generally or specifically related to a company or company activity related to a commercial contract. This data analyzer 120 can include any metric utilize to gauge an attribute of a company in relation to a contract, particularly contract acquisition, a bid, an intent to bid, activity by the entity offering the contract, finalization of a contract, an appeal concerning a contract, a message from any party concerning the contract, etc. In a preferred form, the data analyzer acquires data from a traditional value metric of a company, e.g. stock value from NYSE or NASDAQ or valuation from corporate filings, along with an indication of contract activity. A significant degree of work from the data analyzer 120 relates to a determination of positive vs negative results for a company. Once a positive or negative correlation is determined, there is an attempt to quantify the correlation in some manner with the conclusion generator 140, preferably manifested as a ratings algorithm.

The preferred versions of the conclusion generators 140 are simplistic conclusions 122 such as a + or − without respect to a discrete, quantified value, but in other forms, the conclusions can include a quantifiable value as a new value or a proposed change to an original value. An example of a quantifiable value can include a quantity of contracts, either as a change or a contract total, or a value of a single acquired/sought contract or a summation of multiple contract values acquired in a period of time. The conclusion generator starts with a simplistic determination of a starting value of a company, and then supplies a change in the starting value to an end value. This is performed by the aggregation of initial data from the company, that can be acquired via the webscraper 110, which can be any commercial data related to a company, and in the most basic case, merely the existence of the company. The initial data is correlated to the data output from the conclusion generator, specifically, a rating algorithm therein, to apply a change from the initial value.

To provide actionable, meaningful business intelligence the data from the system 100 is displayed not merely as the data aggregated, but as an artificial depiction in a scrolling ticker reminiscent of a traditional stock market ticker. The present invention utilizes multiple means of artificial, dynamic data visualization 130 to provide easily digestible information to a user. The present invention relies on the notions that education and sophisticated users of data are bombarded with information in readily digestible forms throughout their professional life. It is helpful to thus “borrow” these forms of visualization for analogous and even non-analogous business intelligence data provision. For example, with the present scrolling ticker embodiment of the dynamic data visualization 130, a user involved in the intricacies of government contracting has most likely witnessed a scroller stock market ticker; however, there is not a similar means of providing information concerning government contracts. However, if a similar method were applied to information concerning government contracts, the present invention borrows the recognition and instincts gleaned from the professional's experience with a stock ticker to quickly convey information concerning a government contract status in relation to a company. In the present invention's case, however, the information lacks a basis in measurable fact as output. In other words, a stock ticker exhibits the price and change of stock as it actually exists contemporaneous to the display of the company, price, and change; however, the present invention, when it assigns a display characteristic to a company based on an artificial extrapolation of value that need not have an exact basis in quantifiable fact. Rather the quantification of the present invention need not be true, although because the present invention is related to business intelligence, the quantification should be helpful and relevant—and not contrary to reality. The dynamic data visualization 140 manifested as a scrolling ticker can be wholly preconfigured or manually-adjustable. The preferred scrolling ticker is based on the data gleaned by the webscraper and displayed as a function of (i) a company, (ii) and a quantification of the company's commercial contract activities. In a more preferred version, the ticker provides the company data as an indication of a company along with a numerical change score, e.g. Northrup Grumman 30+1. Additionally, a preferred depiction related directly to contract solicitation activities includes: Northrup Grumman+Contract Number+MOD #+NEW MOD #. In this instance, the company is displayed, along with a contract quantity and a change in contract quantity. In another form, the ticker provides the company data as an indication of a company along with a change in value based on contract values, e.g. Northrup Grumman+Contract Number(MOD #)+$4,500,000.00+$1,000,000.00. In this instance, the company is displayed, along with existing contract values and a change in contract values—either totally or in a specific service sector, e.g. IT Services. In another preferred version, the company data is displayed wherein the data is wholly contained within the corporation representation, e.g. Northrup Grumman. Here the indication of status is contained in the company title, and the depiction of the company in bolder or lighter font (or differently-colored fonts) indicates a positive or negative score. Other exemplary forms of display can include:

Northrup Grumman+Federal Agency+$$ (awarded dollar amount)+Date

Northrup Grumman+$$FYTD (total obligations total fiscal year to date)+Date

Northrup Grumman+Contract Number+BASE YEAR+OPY1 (this means that the federal government decided to extend the period of performance and accept the new option year)+Date

Northrup Grumman+IDV Vehicle Number+TO # (this means that they were awarded a new task order number a government vehicle)+Date

Northrup Grumman+Latest Merger/Acquisition+Date

Nortrup Grumman+Latest Executive Movements+Date

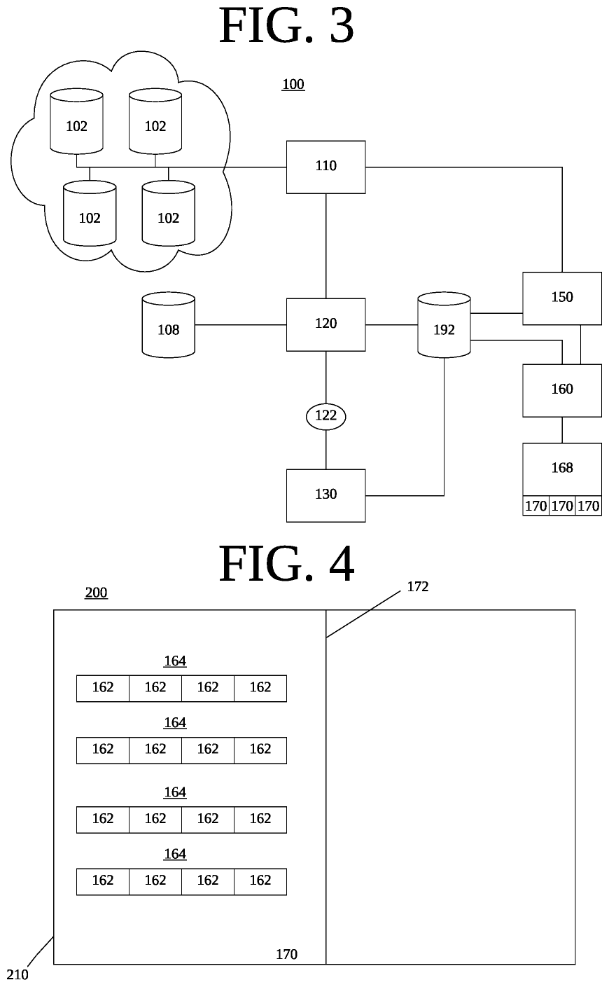

Nortrup Grumman+Lastest Announced Hosting Event+Date In another embodiment of the present invention as depicted in FIGS. 3-4, the present invention includes a business visualization system 100 with a web scraper 110, data analyzer 120, a verification algorithm/bot 190, a scourer 150, an output generator 160 to generate a title, and a graphic user interface (“GUI”) composed of one or more GUI elements 170 and GUI boundaries 172. The present invention of the present embodiment is directed to a GUI dashboard having multiple elements based on user interest. A user in the present invention can be an entity desirous of participating in, or learning about, government contracting activities. A user supplies subject matter concerning contract solicitation activities of interest, and the following are displayed as a business intelligence output: events, contracts, and social information concerning the events and contracts. Certain information provided can be verified while other information need not have any confirmation at all.

The web scraper 110 as characterized above provides access to WAN resources to acquire textual and other data related to contract solicitation activities. The data analyzer 120 of the present embodiment is adapted to review the captured information of the web scraper 110, but for a specialized purpose. The data analyzer is pre-loaded to provide (i) a conclusion based on contract solicitation activities correlated to a government agency, (ii) a conclusion based on events participated in by the government agency correlated to the contract solicitation. Although so much of the present disclosure is directed to contract solicitation and other directly related data, contracts are not wholly won or lost at the bidding and information gathering stages. Contracts have an entire series of life stages that can have a significant span prior to the award and procurement/acquisition stage, including events open to the public and/or specified potential contractors. Contract events include such activities wherein a government agency is allowing interaction with the agency or its agents for the general purposes of the agency or concerning the contract for activities other than strictly fulfillment and award activities. Contract events can include any of the following: (i) Award, (ii) Combined Synopsis/Solicitation, (iii) Combined Synopsis/Solicitation (Modified), (iv) Fair Opportunity, (v) Justification and Approval (J&A), (vi) Presolicitation, (vii) Presolicitation (Modified), (viii) Solicitation, (ix) Solicitation (Modified), (x) Sources Sought, (xi) Sources Sought (Modified), (xii) Special Notice, (xiii) Special Notice (Modified) and the like. These events are generally the terms of art used by agencies in disseminating contract events to the public. However, because these terms are overly specific, and in some instances, largely redundant, the present invention preferably filters these terms of art into predetermined pigeonholes as (i) Award, (ii) Active, (iii) PreSol, and (iv) cancelled. These are preferably sorted as follows:

TABLE 1
Simplification Extrapolation Table

| Original FBO Status | Invention Status |
|---|---|
| Award | Award |
| Combined Synopsis/Solicitation | Active |
| Combined Synopsis/Solicitation | Active |
| (Modified) | |
| Fair Opportunity | Award |
| Justification and Approval | Award |
| (J&A) | |
| Presolicitation | PreSol |
| Presolicitation (Modified) | PreSol |
| Solicitation | Active |
| Solicitation (Modified) | Active |
| Sources Sought | PreSol |
| Sources Sought (Modified) | PreSol |
| Special Notice | (null) |
| Special Notice (Modified) | (null) |

The invention includes Pre-Solicitation events as when events at are in their market research phase while federal agency is drafting and reviewing the requirements and final solicitation documents in preparation for release. The invention characterizes Active Solicitation as when events that are now in the final RFP phase and are actively competing requirements. Federal agencies set a time limit for that event and anticipate receiving competitive proposals at the end of that time limit. The invention includes Awarded Solicitations as when an event is in a procurement/acquired stage. The federal agency post the award and/or sole-source and/or justification and/or urgent requirement announcement on a public website per the national transparency act which typically includes at least the awarded Government Contractor, the Solicitation Number, the Awarded Contract Number, and the Ceiling Value. The invention further provides Cancelled Solicitations as when a federal agency decides to no longer pursue an event. This can be during any phase of the procurement/acquisition lifecycle.

The level of vetting required for different stages of business intelligence need not be single tiered. In the present invention, a multi-tiered approach to vetting commercial contract information is used that varies with the seriousness of the information involved. Information concerning contract awards and attributes require exacting standards of vetting and the verification algorithm 190 of the present invention provides this vetting. The preferred verification algorithm 190 contains instructions calculated to adequately verify solicitation activities and/or events from a direct (or primary) source web resource 102. As attributes of a contract award derive from roughly standardized sets of attributes and notifications distributed by the United States (or other) government, the web scraper 110 can be highly-accurately configured with a high-degree of precision to acquire captured data 192 from a primary source website. The direct source websites can be highly-constricted as government contract awards are posted on a limited set of websites as a primary source. Contract values, contract services, contractor attributes, quantity of permitted subcontractors, etc. are limited in quantity and non-creative. Contract vetting could further include duplication as a source of credibility. For example, the existence of contract information on multiple websites could be counted as a factor in credibility of information in the verification algorithm. Other indicia of credible contract information other than direct sources can spring from a myriad of sources.

Information may be considered credible if it is on a “.gov” or “.edu” or “.mil” “.fed.us” website. The only “.com” is for USPS. Information may be considered credible if it appears on a “checkmarked” verified twitter profile (either personal or agency). There can be a manual or automated review of the media providers or uploaders history and location to see whether s/he has shared useful and credible content in the past, or if s/he is a “scraper”, passing third party content off as its own. For the latter scenario is it often the case that location provides a significant basis of trust; the trustworthiness of uploaders from outside the country of origin can be a basis of suspicion. For example, there may be little reason to trust uploaders in Japan to post content from Syria. Consultation of other sources or validated user content to confirm information is credible.

Other basis of credibility can be cultivated by developing and maintaining relationships with people within the community around the event. Furthermore, the scouring bot or other web scraping bot can be automated to search for the original source of the upload/sequences as an indicator of date—or manually. Furthermore, the system can maintain lists of previously verified material to act as reference for information of the event. The system can verify the historical life of the existing account. Accounts can be correlated to other accounts that have be verified—or are suspicious. Timestamps can be taken into consideration to verify information.

Contract events can derive from direct source WAN resources 102 or indirect source WAN resources 102, however, it is preferred that they derive from direct source websites. Although contract events are often depicted in a more creative and unstructured format, contract events can be relied upon with a degree of vetting as identified by the user. Whether contract events need to derive from direct source websites can be a matter of choice for a user, and the strictures with which the assurance of the contract event data is deemed accurate can be relaxed. Contract events tend to be posted multiple times throughout the Internet (the preferred WAN system) and because data related to a contract event is often the basis for further research, rather than its culmination, contract event data can be supplied in multiple forms (perhaps even one notice for each contract event listing on each WAN resource bearing information related thereto), to allow the user to research the event manually. Of course, events can still have their static data types, e.g. times, places, subject matter, costs, attendee characteristics, etc. Agencies tend to be like other, private companies and can have events, such as: Industry Days, One-on-one Meetings, Technology Demonstrations, Small Business Conferences, Matchmaking Events, Webinars, Small Business Event, Interchange Meeting, Pre-Proposal Conference, Site Visits, Pre-Proposal Conferences, Engagement Days, Forums, Conferences, Summits, Industry Engagement Events, etc.

The present invention further includes a scourer 150 in certain embodiments. A scourer 150 pursuant to the present invention includes a bot for sorting through captured data 192 gleaned from a search by the web scraper 110. In this respect, the scourer does not necessarily perform a primary search of its own but rather restricts the scope of its information to merely the information collected as captured data 192 due to an earlier system routine. The preferred scourer 150 acts as a simplified form of artificial intelligence in the embodiment presently discussed. Although the web scraper 110 of the present invention requires a considerable degree of initial manual interaction, the scourer 150 can be wholly automated to provide results based on information already acquired. This preferred scourer performs two steps, first the review of captured data 192 from the web scraper 110 and second a supplemental search based on the captured data (and preferably restricted thereto) that scrapes supplemental information related to the captured data. This allows the present invention a highly flexible form of intelligence gathering, a restricted and precise and accurate acquisition of contract data related to contract solicitation, and the use of the acquired data as the starting point for a highly structured, but freeform search, of supplemental data related to the acquired contract data. The preferred use of this nested search and scrape technique is to acquire social communications related to contract solicitation activities and events.

It is preferred that the scourer 150, once it has acquired the captured data 192, be less restricted in the scope of its spider of the Internet to seek social communications from social WAN resources 102. The nature of social communications is that they need not be from primary sources and their reliability can be based on the content and substance of the information rather than, necessarily, the source of the information. Contract data concerning an agricultural contract should probably only derive from the U.S. Department of Agriculture and U.S. General Services Administration (GSA); however, a communication regarding why a contract failed or succeeded or the state of its evolution can come from any person on the Internet, whether or not verified to a particular source. Furthermore, social communications are less likely to be formally structured so that the source of a communication disparaging a contractor may be unlikely to characterize the source entity by name, position/rank, and experience of the source entity. Rather, the information can be judged based on the “four-corners” of the communication, so that in the communication: “The contractor for XYZ Corp. never supplied the widgets in the shape that we desired” can have multiple uses unrelated to the accuracy of the statement. The statement may even be untrue and be used to prove not that the widgets were misshaped, but rather that the managers overseeing the supply have impossible standards. This is purely an example, but in many instances information can be reliable even when untrue—or for purposes of objective analysis, unverified. Untrue information concerning a contract has little to no value; information that a contract has a value of $1,000,000.00 when in reality it is for $2,000,000.00 serves only to waste time and resources to uncover the truth. Strategies can be based as much on social communications as hard data. Social commentary can help a user develop strategies with real facts, figures and trends. Social dialouge can be a platform to encourage meaningful dialogue around how everything in GovCon is connected. Conversations, unlike “official” reports and issuances, tend to avoids generalities and lofty assumptions. Social reviews can aid a user in creating a decision maker profile as it is important to know the psychological profile of federal buyers because it will inform a company's strategy. People buy products and services, and the present invention focuses on accessing storytelling elements behind contracts, whereas other tools are strictly data science. The social commentary helps to build out a strategy on how to best connect with a decision maker, and governs how you handle that client. The data acquired from the scourer is passed back to the database of captured data 192 preferably to include metadata that the captured data 192 derived from the scourer rather than the scraper.

The captured data 192 is then passed to a preferred GUI of the present invention composed of one or more GUI elements 170 and one or more GUI boundaries 172. A GUI element of the present invention is depiction of information detailing information concerning business intelligence. The present invention is meant to be a tool, and tools are meant not only to be useful, but useable. Therefore, the present invention includes logical divisions between the types of GUI elements 170 that are separated by boundaries 172, which may include express data elements, e.g., lines, shapes, backgrounds, etc. or less explicit elements, e.g., absence of information or white space pronouncedly marking data sets one from the other. The captured data 192, as shown in FIG. 4 is best displayed as highly, uniformly structured data in the GUI that is systematically and uniformly arranged by the output generator 160. The output generator 160 provides the information for the data element 170 subsets that are depicted as sections of uniform data output 164 composed of data elements 162.

The output generator 160 preferably includes a title generator outputting a uniform title script comprising contract and event data variables 164, generated from a keyword search of said captured information. In other words, the present invention supplies “containers” as data variables 162 into which the present invention searches to determine whether information exists to fill the appropriate container. A significant source of utility of the present invention resides in the fact that data sets are supplied to a user in a manner that allows direct, meaningful comparisons of highly disparate information. Indeed, there may even be significant value in determining that certain variables have no data to fill them in the generation of structured data output 164. Any valuable form of information constituting business intelligence may have its data element 170 section, including in a preferred tool a recitation of (i) contracts, (ii) contract events, and (iii) social commentary concerning the contracts or contract events.

In this preferred embodiment there are three data elements 170 described above with two data boundaries 172. The data elements 170 are filled with similar information, such that one data element contains information restricted to a single genre, e.g. contract solicitations. By genre, it is meant commercial activity. Information listings within the data element are uniformly depicted to allow direct, quick comparisons of data output 164 whereby each data output 164 should result from a single finding of commercial activity by the web scraper 110. Each data output 164 includes variables 162 that are composed of the attributes of the information found. For contract solicitation activities as a data element, a preferred listing of variables includes: Agency, Date of Offer, Date of Award, Due Date of Submission, Contract Value, Attributes of Preferred Contractor, Services Required, System (of the present invention) ID, Original Posted Date, Date Updated Posted, Response Due Date, Award Date, Contract Name, Status, Agency, Office, Solicitation Number, GSA Schedule RFQ Number, Incumbent, Awarded Contract Number, Awardee, Est. Contract Value, Award Amount, Actual Contract Value, Set-Aside, Original Set-Aside, Description, POC, POC2, NAICS, NAICS FULL, PSC Code, Link, Source, and Pulse Notes.

These variables 162 can be depicted in any order desirous for the facile ingestion of business intelligence, and in certain embodiments can be arranged by the user such that preferences for one variable over another can alter the sequence of the data output 164 listings. For contract events, preferred variables and sources include: OSDBU Web Sites, PTAC, External Industry Websites (AFCEA, Potomac Officers Club, SECAF,NCMA, PSC etc.), FBO.gov (SB Events), FBO.gov (Vendor Collaboration), GovLoop, SBA, GSA, DOD OSDBU, Eventbrite.

The use of social commentary as a distinct data element 170 presents more difficulty for arrangement because commentary rarely includes uniform or similar structuring. That is not to say that some consideration may not be placed on commentary devoted to contract activities, for example, in preferred embodiments, if present, preferred commentary variables may include: WAN Resource from which found; Employer of Source of Commentary; Contract (If Named); Employment Position of Source of Commentary; Prior Relationship between User and Source of Commentary; etc. Because social commentary is such a freewheeling abundance of data, as mentioned earlier it is preferred that the social commentary data element is restricted, preferably through metadata linkage, to only those contract activities and contract events found and verified in a other data elements depicted in the business intelligence GUI.

There are multiple ways that such nested forms of information-about-information could be utilized. In a first embodiment, hearsay and other commentary data 164 and commentary variables 162 could be depicted merely because highly verified data has been allowed to exist in another data element. In a second embodiment, the commentary data 164 may only be depicted as visible when a cursor or other indication of user exploration hovers over a data output 164 list. For example, hovering over a specific Defense Contract may activate metadata applied to social commentary captured data 192 related to that particular Defense Contract or that genre of Defense Contract (e.g., servicing capital ships). Furthermore, the level of abstraction may be altered in the social commentary data element such that with a virtual lever, the relationship between a particular contract or agency event and social commentary may be restricted or relaxed. In a most restricted sense, the social commentary data elements may begin purely with commentary related to that specific contract, while turning the lever may then relax the social commentary data output 164 to include social commentary related to the genre of contract. Further relaxation may raise the level of abstraction to include the agency from which the contract, or the genre of contracts, derives. Further relaxation may raise the level of abstraction to include merely the service from which the agency, contract, or genre of the contract derives.

If there is social commentary regarding their family life, pets, weekend activities, travels, etc.—those are prime examples of data that gets filtered out. If there is social commentary regarding new articles/information they read, any new changes to their job status/job title, any postings on what events they are or have attended, etc., such would survive the filter.

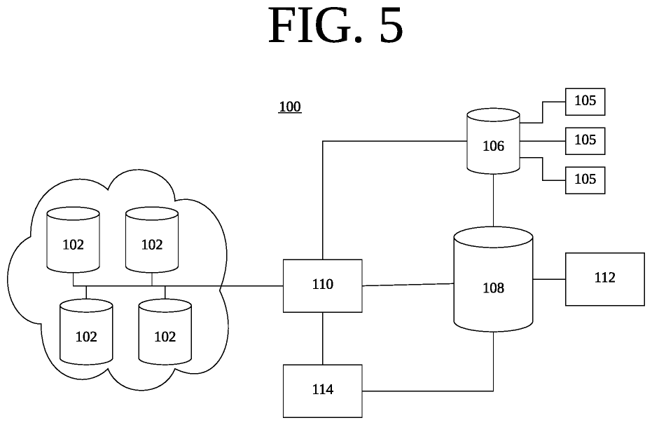

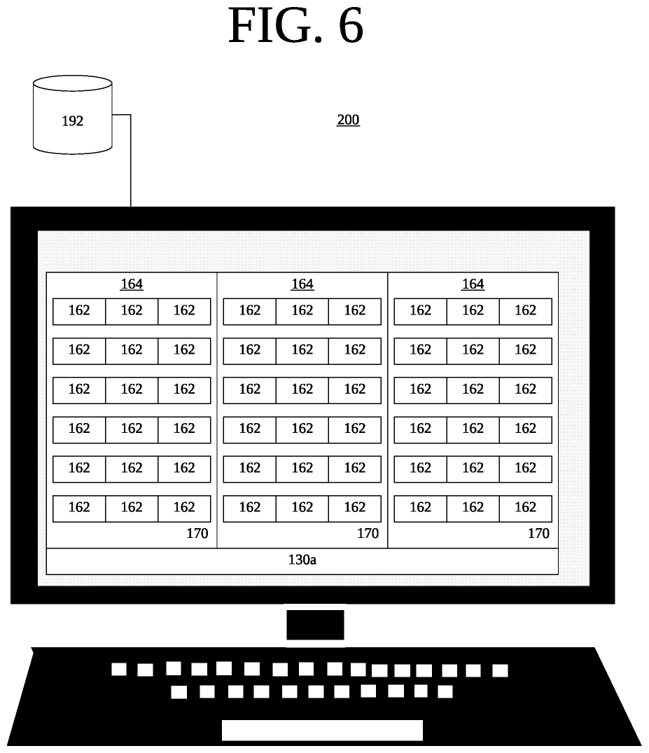

One of the chief uses of the present invention in acquiring business intelligence is the use as a juxtaposition system. In the embodiment of FIGS. 5-6, the present invention provides exactly that. A rating index is generated by the aggregation of stock price, merger info, and public announcements. Then scores are created for government contractors, which is then applied to the activity of the government contracts in relation to those specific government contractors. For example, lists could be culled on the basis of ‘least participated in’ by big/active/hot players. Contracts could then be matched to prospective likely contractors based on reality, and furthermore, contracting partners could find each other based on synergy, gaps, valuation, etc.

The present invention includes a contract web scraper 150 adapted to access contract solicitation WAN resources, for the capture of information related to contract solicitation activities. In addition to the web scraper, an entity either as a separate routine or as a supplement to the web scraper 150 as a single unit re-worked to provide multiple functions. And such is a general characteristic of the present invention, the discussion of an “entity” scraper as opposed to a “web” scraper does not necessarily indicate that these are separate units within the present invention. Similar code, provided with different key words could supply such differentiation and specialization necessary to practice the present invention. The entity web scraper is tuned to access business resource databases, e.g., Dunn and Bradstreet and news resources, for the capture of information related to entity contract participation attributes associated with a competitive entity. The attributes of a company can include, for example, employee count, Gross revenue, contracts/year, whether prime or sub.

Here, the present invention ceases to be agnostic to the particular user utilizing the business intelligence system 100. The present invention includes a devoted user profile 112. The user profile 112 can be based on a question/answer set provided to a subscription user or supplied to entities as forms irrespective of the relationship between the user and the present invention. The present invention aggregates a client profile database 108 that includes user profiles aggregated as well as information concerning a company as acquired from WAN resources. Here, the entity web scraper 110 seeks information related to contracting entities in toto. The information sought by the present invention includes any contracting information that may be related to a company in its activities in seeking, performing, and learning about contracts. Company information may include: Name, Size, Employees, Bases of Operation, Value, Contracts Serviced, Services/Goods Offered, Prices of Goods/Services Offered, Length of Contracts, Existence of Bidding Vehicles, Contractor Attributes, Agencies Services, Percent of Contracts Passed to Subcontractors, Satisfaction, Appeals, Bid Attributes, etc. Other information that could be learned about an organization: Merger and Acquisition History, Recent Executive Leadership Movements, Most Recent Press Releases, Court Case Filings, Quarterly Reports and Numbers, Relevant Federal Regulations, Certifications, Clearance-Levels, Licenses, Affiliations, Organizations, etc.

Accordingly, a large dossier database 106 of competitor profiles 105 is created which provides a business intelligence comparison between the user and other industry players. The number of advantages related to understanding the state of your, i.e., the user's, company and operations/activities in relation to those of others is too numerous to list in any meaningful way. The business intelligence gleaned from the present invention can include and/or permit: Access to competitive intelligence; On-demand trend analysis analyzing government procurement trends; Price analysis for what market rates are; Less labor intensive yet efficient; Clients and customers are assured that the information they see is the latest one; Pull relevant material or data from all corners of the Internet—data that you thought never existed; Faster education; complete set of government spending data available on the market—all within a single point of access; More search tools for accessing contacts, making it easier for clients to connect with government buyers and find partners for teaming; Power keyword searching based on machine learning and relational database building techniques; rigorous proprietary research methodologies to ensure our insights are independent and objective; Created by a team of government contracting experts which understand their role, business and industry; Forward-thinking insights, verified peer-driven research, and robust metrics and data to help government contractors make the right decisions and bid with intent.

In a preferred version of the present invention a user profile 112 is created that indicates the size and scope of a user's contracting operations. One of the more profound questions asked by entrepreneur's is whether the business is operating at optimum efficiency. One of the best ways of answering this question is through comparison and contrast between similarly situated businesses. For example, a user may compare the size and capabilities of its business in relation to a benchmark (created by the present invention through statistical analysis of competitor profiles 105) and find that businesses similarly-situated tend to charge more-per-unit for goods or acquire contracts for longer duration periods. In such instances, the user may seek guidance in aiding its company to reach and surpass the benchmark. Furthermore, the present invention may have significant utility directly in the contracting sphere because contract entities often want to ensure that they are not over-paying for goods/services. Statistical treatments of existing contracts may provide certification that payment and services are within a particular threshold, or if not, seek an explanation for why the deviation exists.

The dossier database 106 holds not only the entity profiles 105 but also scores as a shorthand related to the entity profiles and activities. Rather than attempting to rate the competitive entities sua sponte each time that a user seeks a comparison, the present invention can maximize processing efficiency by providing a static, indefinite score to any aspect of the entity or its activities. The scores may have a direct relationship between the entity and its activities, e.g. a contract value score of $5,000,000,000.00, or the scores may be artificial and lack a direct translation to real-world data, e.g., a ratio of positive statements to negative statements to indicate contracting satisfaction. Other contract activities that could hold scores for direct, if artificial comparisons, include: Relational database tracks the users' historical behavioral tendencies, clicks, and selections. The present invention can match these historical trends with their organizational profile on SAM.gov which includes Functional Areas, NAICS, PSC, Facility Clearance, etc. Any of the scores for the competitor could similarly be applied to the user, and therefore, the user profile 112 holds scores for the user that can be directly comparable to competitors.

A contract aggregator 114 of the present invention takes the additional step beyond the mere comparison of the user to competitors, or competitor to competitor, and provides active business intelligence on the “next step” to the user. Here, the present invention utilizes the scores for the user and competitors to indicate contracts acquired by entities comparable to the user. This assures that the user is appropriately utilizing assets and resources to seek contracts that it is likely to acquire—rather than based in fantasy. To the extent that a contract may never have been awarded to a contractor the size of user may be a strong indication that the user will not be capable of acquiring a similar contract. Furthermore, the present invention could identify the differences between competitive entity profiles and user profiles that lead to the user acquiring contracts similar to those of the competitive entity, e.g. the necessity of hiring employees with specific credentials, or lowering the costs of services, etc.

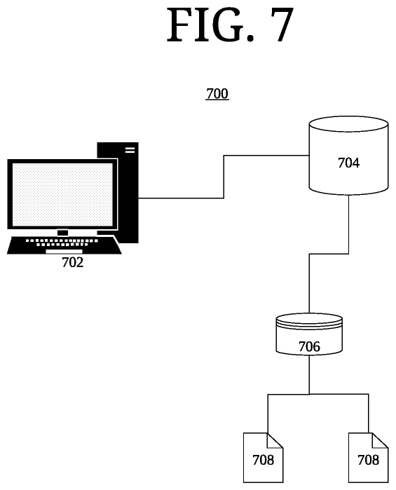

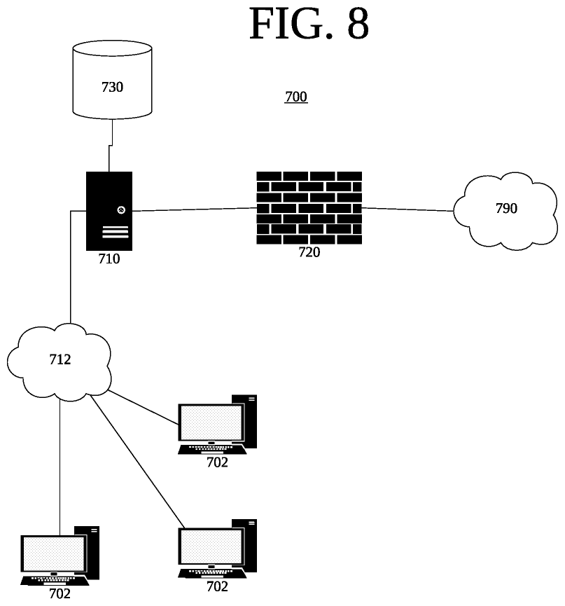

FIGS. 7-8 depict a computer ecosystem 700 of the present invention. By ecosystem it is meant one or more computers 702 that are organizationally related. The ecosystem may include computers under common ownership, computers that belong to the same network or series of networks, computers that are collaborating, etc. The present invention may be provided as a computer program product, or software that may include a computer-readable storage medium 704 having stored thereon instructions, which may be used to perform the process of the present invention across a computer ecosystem 700 according to the various embodiments disclosed herein.

A computer 702 of the present invention may include any combination of one or more computer readable media 704. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium 704 may be any tangible medium that can contain, or store a program for use by or in connection with an instruction execution system, apparatus, or device.

A computer readable signal medium 704 may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures described below illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Furthermore, the functionality of one block may be subsumed by the functionality of another block as a substep thereof. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

An ecosystem 700 may further include a computer network or data network that allows computers to exchange data. In a computer network of the present invention, networked computing devices pass data to each other along data connections. The connections between nodes are established using cable media, wireless media, or other media. The Internet or other exterior network 790 may be a component of the ecosystem 700. Nodes may include hosts such as personal computers, phones, servers, and networking hardware. Two such devices are networked together when one device is able to exchange information with the other device, whether or not they have a direct connection to each other. Computer networks of the present invention support applications such as access to the World Wide Web, shared use of application and storage servers, printers, and fax machines, and use of email and instant messaging applications. Computer networks may be included irrespective of the physical media used to transmit their signals, the communications protocols to organize network traffic, the network's size, topology, and organizational intent.

It is preferred that the network of the present invention have at least one boundary 720, and potentially multiple boundaries if a demilitarized zone is utilized. The boundary 720 may include any number of layers designed to regulate and secure the flow of information between networks. Boundary layers of the present invention may include enterprise content management software, firewalls, filters, threat management software, alarms, etc. Software for establishing a boundary may be run on a server 710 with server storage 730 of the present invention, which may include directory services controlling access credentials.

To combat security risks posed by network connections, firewalls are frequently used. A firewall may be a hardware or software component that filters network traffic so that communications with unauthorized third parties are blocked but legitimate network functions may be carried out. Frequently, the filters applied by a firewall are specified by a set of policies defining characteristics of network messages that either should pass through the firewall or that should be blocked. Because different levels of communication may be appropriate depending on the origin or destination of messages, firewall policies may be provided for each application that executes on a computing device and communicates over a network.

A firewall may have an outward side facing a global network, such as the Internet. The opposite side of the firewall may be a private network that is protected by the firewall. The private network may include any number of host machines (e.g., computers) each addressable by its own IP address. The physical construction of the network may be such that all data packets intended for one of the IP addresses behind the firewall pass through the firewall. Using the firewall rules, which may be set by a network administrator or other user, the firewall may determine whether to allow or deny certain data packets and/or determine where to route particular data packets based on the IP addresses to which the packets are directed. The determination of where to route data packets may be done using the IP addresses of the host machines in the private network.

Depending on the addressing scheme used by the network, the IP addresses of the host machines may be static or dynamic. Static IP addresses do not change over time, and thus once they are set in the firewall rules, there is no need to update them. The Internet Protocol version Four (IPv4) addressing system commonly uses static addressing, while IPv6 may use dynamic addressing. Dynamic IP addresses may change over time and thus, there is a need to update the firewall rules as changes occur. When a small Local Area Network (LAN), such as a domestic network in a private residence, is linked to a larger network such as the Internet, the link is often through a gateway router acting as a firewall. One of the functions of the firewall is to protect the LAN from intrusion from outside.

A service directory accessible by a server 710, usually on server storage 730, stores information about network resources across a domain. An example of a directory service is Active Directory. The main purpose of Active Directory is to provide central authentication and authorization services for Windows-based computers. Active Directory also allows administrators to assign policies, deploy software, and apply critical updates to an organization. Active Directory stores information and settings in a central database.

An Active Directory structure is a hierarchical framework of objects. The objects fall into three broad categories: resources (e.g. printers), services (e.g. e-mail) and users (e.g., user accounts and groups). The Active Directory provides information on the objects, organizes the objects, controls access and sets security. Certain objects can also be containers of other objects. An object is uniquely identified by its name and has a set of attributes—the characteristics and information that the object can contain—defined by a schema, which also determines the kind of objects that can be stored in the Active Directory.

Typically, the highest object in the hierarchy is the domain. The domain can be further sub-divided into containers called Organizational Units. Organizational units give a semblance of structure to the organization either based on administrative structure or geographical structure. The organizational unit is the common level at which to apply group policies, which are Active Directory objects themselves called Group Policy Objects. Policies can also be applied to individual objects or attributes as well as at the site level (i.e., one or more IP subnets).

The present invention may use one of more communication networks to foster information exchange throughout the computers of the ecosystem. Communication networks might either be private or public. In a private network, communications between multiple computers occur in a secure environment that prevents access from outside the network without appropriate authentication. These networks are considered as “trusted” networks because the communication signals securely travel from one computer to another within the private network without being exposed to the external environment.

Public networks such as the Internet, on the other hand, are not secure because the communication over these networks is not private and is susceptible to interception by other computers. In addition, the public networks cannot guarantee the delivery of the data packets being sent. They allow packets to be injected into, or ejected out of, the networks indiscriminately, and analyzed while in transit. To keep data sent over a public network private, a Virtual Private Network (VPN) is commonly established on top of a public network when two computers use the public network to communicate with each other. In a Virtual Private Network, data sent from one computer to another is encrypted by a security gateway and transmitted in encrypted form over the public network to a second security gateway connected to the receiving computer. The second gateway decrypts the data before forwarding it to the receiving computer. Such a private channel established on top of another network is referred to as a network tunnel.

In order to set up a Virtual Private Network, a user first establishes a path to a VPN server and goes through an AAA process (Authentication, Authorization and Accounting) for identification and authorization to create a secure tunnel with the server. Once the user is authorized, a secure network tunnel is established between the user and the VPN server over the public network, using a VPN protocol such as IPsec. This process requires a VPN client on the user's side, a VPN server and other VPN hardware on the other side of the tunnel, as well as appropriate user configurations.

Today's private networks often include wireless networks such as WiMAX to accommodate mobile access. In addition, to provide mobility access in a large geographic area, a private enterprise often relies on third-party wireless infrastructures besides its own wireless network. In this case, a user's device would need to be authenticated by both a third-party gateway and an enterprise authentication server before it could access the enterprise network. User credentials are typically requested by and securely returned to the third-party gateway. Once the user is authenticated and authorized, the user may communicate with the third-party wireless gateway.

The present invention includes files 708, which may include executable instructions by which the present invention runs, or files upon and with which the present invention interacts. The documents may be on local storage 704 or shared storage 730 and be created, accessed, edited, and/or otherwise modified using any of a number of applications, including for example and without limitation Final Cut Pro, Avid, Microsoft Office applications (Word, Excel, Power Point, Outlook, Visio, etc.), Adobe Reader or Acrobat, AutoCAD, SolidWorks, or any other suitable document editing application. The content of the documents may be audio tracks, video clips, images, word processing documents, presentations, spreadsheets, business documents, engineering documents, databases, etc.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

What is claimed is:

1. A business visualization system comprising:
a web scraper, adapted to access contract solicitation WAN resources, for the capture of information related to contract solicitation activities;
a data analyzer, adapted to review the captured information from said web scraper, to provide a conclusion based on contract solicitation activities correlated to a company;
a rating algorithm, adapted to provide ascribe a quantitative score to said company based on said conclusion;
a scrolling ticker positioned on a visual electronic display displaying said company affected by said quantitative score with time indicia, including sequential arrangement, and a visual indication of said quantitative score.

2. The system of claim 1 wherein said visual indication includes color-coding based on said contract activities.

3. The system of claim 2 wherein said visual indication includes a textual characterization of said contract activities associated with said quantitative score.

4. The system of claim 3 wherein textual characterization hotlinks to said captured information.

5. A business visualization system comprising:
a web scraper, adapted to access contract solicitation WAN resources, for the capture of information related to contract solicitation activities;
a data analyzer, adapted to review the captured information from said web scraper, to provide (i) a conclusion based on contract solicitation activities correlated to a government agency, (ii) a conclusion based on events participated in by said government agency correlated to said contract solicitation activities;
a verification algorithm, adapted to verify said solicitation activities and said events from a primary source web resource;
a scourer for performing a supplemental search of statement-based web resources based on (i) said captured information and (ii) at least one of (a) said conclusions based on contract solicitation activities, and (b) said conclusion based on events participated in by said government agencies; said supplement search resulting in captured statement data;
a title generator outputting a uniform title script comprising contract and event variables, generated from a keyword search of said captured information;
a graphic user interface having a first data boundary consisting of listings of uniform title scripts concluded to be contract activities, a second data boundary consisting of listings of uniform title scripts concluded to be events; and a third data boundary consisting of listing of captured statement data consisting of information related to said contract activities and said events.

6. The system of claim 5 wherein said a title generator outputs a uniform title script comprising statement variables gleaned from said captured statement data.

7. The system of claim 6 wherein said generator outputs a uniform title script comprising statement variables gleaned from a source of said captured statement data.

8. The system of claim 5 wherein said contract events are correlated to, and graphically displayed in said graphic user interface substantially adjacent to, said contract solicitation.

9. The system of claim 8 wherein said graphic user interface displays solely said contract events correlated to said contract solicitation activities only when said uniform title script of a specific member of said contract events is selected.

10. The system of claim 9 wherein said uniform title script of said contact events shares a common variable with said contract solicitation activity correlated thereto.

11. The system of claim 8 wherein said uniform title script of said contact events shares a common variable with said contract solicitation activity correlated thereto.

12. A business visualization system comprising:
a contract web scraper, adapted to access contract solicitation WAN resources, for the capture of information related to contract solicitation activities;
an entity web scraper, adapted to access business resource databases, for the capture of information related to entity contract participation attributes associated with a competitive entity;
a dossier database for the aggregation of competitive entity profiles based on both (i) said contract solicitation activities, and (ii) said entity contract participation attributes; and said competitive entity profiles including an entity profile score;
a user profiler for collection of user contract participation attributes related to the user and generating a user profile with a user profile score; and
a contract aggregator for arranging contract solicitation activities concluded to be contemporaneously available based on said user profile score.

13. The system of claim 12 further comprising a comparator for juxtaposition of said entity profile score to said user profile and generating a juxtaposition score; and wherein contract aggregator for arranging contract solicitation activities concluded to be contemporaneously available is based on said juxtaposition score.

14. The system of claim 12 wherein said juxtaposition indicates a characteristic of said user profile calculated to be deficient in said entity profile.

15. The system of claim 13 wherein said juxtaposition indicates a characteristic of said user profile calculated to be lacking in said entity profile.

16. The system of claim 12 wherein said juxtaposition is based on a location characteristic of said user profile and said entity profile.
